(19) United States
(12) Patent Application Publication
(10) Pub. No.: US 2007/0121243 A1
(43) Pub. Date: May 31, 2007

(54) Spindle motor assembly and hard disk drive having the same

(75) Inventors: Yong-kyu Byun, Yongin-si (KR); Cheol-soon Kim, Anyang-si (KR); Min-pyo Hong, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/583,833

(22) Filed: Oct. 20, 2006

(30) Foreign Application Priority Data
Oct. 27, 2005 (KR) 2005-101750

(51) Int. Cl. G11B 17/02

(52) U.S. Cl. 360/99.08

(57) ABSTRACT

A spindle motor assembly and a hard disk drive having the spindle motor assembly. The spindle motor assembly includes a data storage disk to store data and having a parking region in which to park a read/write head, a spindle motor to drive the data storage disk and having a hub around which the data storage disk is fitted, and a clamp member to fix the data storage disk on the hub. The clamp member has a vibration restriction portion formed on a circumferential outer edge thereof to face the parking region and to form a marginal gap with the disk.

### CROSS-REFERENCE TO RELATED APPLICATIONS

This application claims the benefit of Korean Patent Application No. 10-2005-0101750, filed on Oct. 27, 2005, in the Korean Intellectual Property Office, the disclosure of which is incorporated herein in its entirety by reference.

### BACKGROUND OF THE INVENTION

1. Field of the Invention

The present general inventive concept relates to a spindle motor assembly and a hard disk drive having the same, and more particularly, to a spindle motor assembly having improved impact resistance and a hard disk drive assembly having the spindle motor assembly.

2. Description of the Related Art

A hard disk drive is a storage device that records data on a disk or reads the data stored on the data storage disk using a read/write head that approaches a surface of the data storage disk. The read/write head is rotatably mounted on a spindle motor. In order to record or read the data, the read/write head is lifted slightly from a recording surface of the rotating disk and moved to a desired location by an actuator. When the hard disk drive does not operate (i.e., when the hard disk drive does not rotate the disk), the read/write head is parked at a location away from the recording surface of the data storage disk so that the head does not collide with the recording surface when an impact is applied to the hard disk drive. A read/write head parking system used to park the read/write head can be classified as either a contact start stop (CSS) type or a ramp type.

In the CSS type parking system, the read/write head is parked in a parking zone disposed at an inner circumference of the data storage disk. In the ramp type parking system, the read/write head is parked on a ramp that is adjacent to an outer circumference of the data storage disk.

FIG. 1 illustrates a perspective view of a conventional hard disk drive having the ramp type parking system. Referring to FIG. 1, the hard disk drive includes a cover member 11 and a frame member 12 assembled to face each other. The hard disk drive further includes a spindle motor assembly and an actuator 30 accommodated between the cover member 11 and the frame member 12.

The spindle motor assembly includes a data storage disk 50, a spindle motor 60 on which the data storage disk 50 is mounted to rotate together with the spindle motor 60, a clamp member 20 for securely fixing the data storage disk 50 onto the spindle motor 60 to rotate the data storage disk 50 together with the spindle motor 60, and a screw member 55 coupled to the spindle motor 60 via a hole in the clamp member 20.

The actuator 30 includes a swing arm 32 pivotally assembled on an actuator pivot 31, a suspension 35 mounted on a front end of the swing arm 32, a read/write head (not shown) mounted on the suspension 35, and a voice coil motor 40 pivoting the swing arm 32 clockwise or counterclockwise to move the read/write head to a target location of the data storage disk 50.

When the hard disk drive is turned on and the data storage disk 50 starts rotating, the swing arm 32 pivots counterclockwise to load the read/write head on the data storage disk 50. When the hard disk drive is turned off and the data storage disk 50 stops rotating, the swing arm 32 rotates clockwise to unload the read/write head on a ramp 90 disposed at a location adjacent to an outer circumference of the data storage disk 50.

The ramp type parking system of the hard disk drive minimizes the effect of impact to the hard disk drive. However, an additional component (i.e., the ramp 90) has to be mounted in the hard disk drive, which increases the number of work or manufacturing operations. Also, an additional space must be provided in the hard disk drive in which to install the ramp 90, thereby making an overall size of the hard disk drive larger in order to accommodate the ramp 90. Furthermore, in order to stably park the read/write head on the ramp 90, the data can not be stored in an edge region of the data storage disk 50. This causes a structural limitation in increasing the storage capacity of the data storage disk 50.

On the other hand, the CCS type parking system of a hard disk drive has low manufacturing costs, and a small thickness, weight, and length. However, since the CCS type parking system of the hard disk drive does not minimize the effect of an impact to the hard disk drive, the CCS type hard disk drive cannot be actively used for portable devices.

### SUMMARY OF THE INVENTION

The present general inventive concept provides a spindle motor assembly that has an improved anti-impact property, uses a CCS type parking system that can be manufactured inexpensively, has a compact size, and provides for an increase in a storage capacity of a storage disk. The present general inventive concept also provides a hard disk drive having the spindle motor assembly.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing a spindle motor assembly including a data storage disk to store data and having a parking region in which to park a read/write head, a spindle motor to drive the data storage disk, the spindle motor having a hub around which the data storage disk is fitted, and a clamp member to fix the data storage disk on the hub. The clamp member has a vibration restriction portion formed along a circumferential outer edge thereof to face the parking region to form a marginal gap with a surface of the data storage disk.

The clamp member may include a circumferential pressure portion gently protruding toward the surface of the disk and urged to contact the surface of the disk, and the vibration restriction portion extends from the circumferential pressure portion in a radial direction.

The spindle motor assembly may further include a damping member disposed on a surface of the vibration restriction portion to face the disk.

The damping member may be integrally formed with the clamp member through an injection molding process.

The damping member may be formed to have a rim-shape corresponding to the vibration restriction portion and a plurality of coupling protrusions spaced apart from each other by a predetermined distance.

The vibration restriction portion may include a plurality of coupling holes in which the respective protrusions of the damping member are fitted.

The damping member may be formed of a flexible plastic material.

The parking region may be formed on a circumferential inner edge of the disk.

The read/write head may be located between the parking region of the disk and the vibration restriction portion of the clamp when the disk stops rotating.

The foregoing and/or other aspects of the present general inventive concept are also achieved by providing a spindle motor assembly, including a spindle motor, a disk disposed on the spindle motor and being rotatable by the spindle motor, and a clamp member disposed on the disk to clamp the disk to the spindle motor and having a pressure portion to contact the disk around a circular portion thereof and a vibration restriction portion extending away from the pressure portion along a surface of the disk to define a space with the surface of the disk along an outer circumference of the pressure portion.

The foregoing and/or other aspects of the present general inventive concept are also achieved by providing a hard disk drive including an actuator to move a read/write head attached to a front end thereof to a selected location, a data storage disk to store data and having a parking region in which to park the read/write head, a spindle motor to drive the data storage disk and having a hub around which the data storage disk is fitted, and a clamp member to fix the data storage disk on the hub and having a vibration restriction portion formed on a circumferential outer edge thereof, the vibration restriction portion facing the parking region and forming a marginal gap with the disk.

The actuator may include a suspension to which the read/write head is attached and having a damping protrusion formed at a front end thereof, a swing arm to support the suspension and to pivot about a pivot axis, and a voice coil motor to drive the swing arm.

The damping protrusion may be semi-spherical and may be formed of a flexible plastic material.

The foregoing and/or other aspects of the present general inventive concept are also achieved by providing a hard disk drive, including a spindle motor, a disk disposed on the spindle motor, a clamp member disposed on the disk and the spindle motor to clamp the disk to the spindle motor and having a restriction portion extending parallel to the disk around an outer circumference of the clamp member, and a magnetic head assembly having a suspension with a magnetic head disposed thereon that is movable between the restriction portion and the disk.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a perspective view illustrating a conventional hard disk drive;

FIG. 2 is a perspective view illustrating a hard disk drive having a spindle motor assembly according to an embodiment of the present general inventive concept;

FIG. 3 is a plane view illustrating an operation of the hard disk drive of FIG. 2;

FIG. 4 is a sectional view illustrating the spindle motor assembly of the hard disk drive taken along lines IV-IV of FIG. 2;

FIG. 5 is a side view illustrating the hard disk drive of FIG. 3 as seen from a direction V;

FIG. 6 is a perspective view illustrating a damping member and a clamp member of the hard disk drive of FIG. 2, according to an embodiment of the present general inventive concept;

FIG. 7 is a sectional view illustrating the damping member and the clamp member of the hard disk drive taken along lines VII-VII of FIG. 6; and

FIG. 8 is a side view illustrating a portion of a hard disk drive employing the clamp member and the damping member of FIG. 6, according to an embodiment of the present general inventive concept.

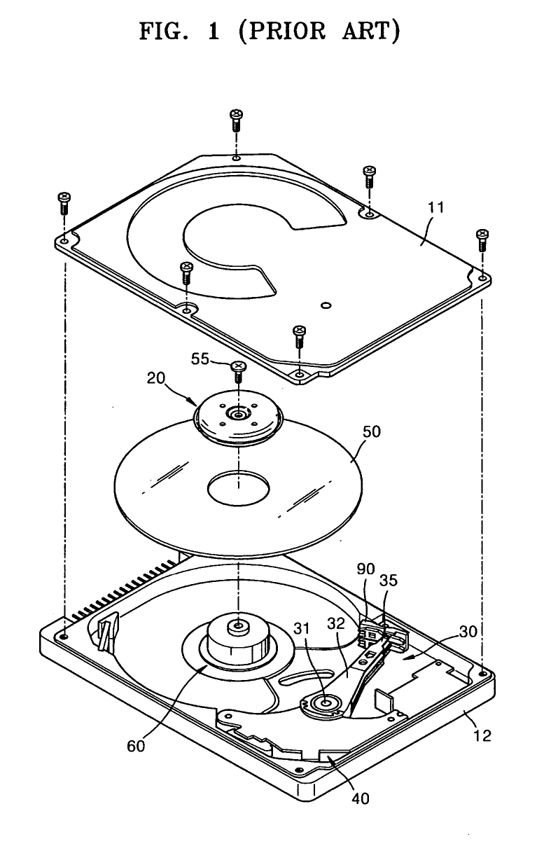

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

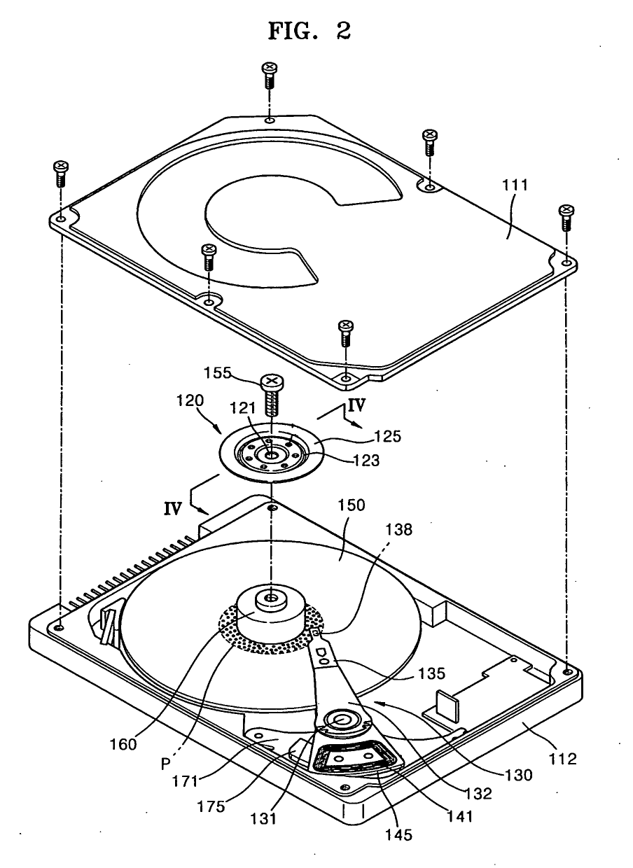

FIG. 2 is a perspective view illustrating a hard disk drive having a spindle motor assembly according to an embodiment of the present general inventive concept. Referring to FIG. 2, the hard disk drive includes a data storage disk 150, a spindle motor 160 to rotate the data storage disk 150, a clamp member 120 to fix the data storage disk 150 onto the spindle motor 160, and an actuator 130 to move a read/write head 138 that reads and writes data to and from a predetermined location(s) of the data storage disk 150. The spindle motor assembly includes the data storage disk 150, the spindle motor 160, and the clamp member 120. The hard disk drive further includes a base member 112 and a cover member 111 to be coupled to each other to house the spindle motor assembly, the actuator 130, etc.

The spindle motor 160 is installed on the base member 112 of the hard disk drive. One or more data storage disks 150 are installed on the spindle motor 160. The data storage disk 150 is rotated at a predetermined angular velocity by the spindle motor 160. A parking region P, where the data are not stored, is formed along a circumferential inner edge of the data storage disk 150. The parking region P is provided to allow the read/write head 138 to be stably seated thereon (i.e., parked) when the data storage disk 150 stops rotating. A plurality of bumps may be evenly distributed on an entire surface of the parking region P so that the read/write head 138 sitting on the surface of the data storage disk 150 can effectively rise above the surface of the data storage disk 150 when the data storage disk 150 starts rotating.

The clamp member 120 urges the data storage disk 150 onto the spindle motor 160. When a screw member 155 is screw-coupled to an upper end of the spindle motor 160 through a central hole 121 of the clamp member 120, the clamp member 120 contacts the data storage disk 150 with a predetermined pressure. The clamp member 120 includes a vibration restriction portion 125 at an outer portion thereof that corresponds to the parking region P in a vertical direction. The vibration restriction portion 125 will be described later.

The actuator 130 includes an actuator pivot 131 installed on the base member 112, a swing arm 132, a suspension 135, the read/write head 138, a coil supporting unit 145, and a voice coil motor (VCM) having a VCM coil 141, a magnet 175, and a yoke 171. The swing arm 132 is pivotally coupled to the actuator pivot 131. The suspension 135 is coupled to a front end of the swing arm 132 to supportably bias the read/write head 138 toward the surface of the data storage disk 150. The coil supporting unit 145 is provided on a rear end of the swing arm 132.

The voice coil motor provides a driving force to rotate the swing arm 132. That is, the swing arm 132 pivots about the actuator pivot 131 in a direction according to Fleming's left-hand rule by an interaction between a current applied to the VCM coil 141 and an electric field formed by the magnet 175. The VCM coil 141 is assembled on the coil supporting unit 145. The magnet 175 faces the VCM coil 141. The magnet 175 is supported on the yoke 171.

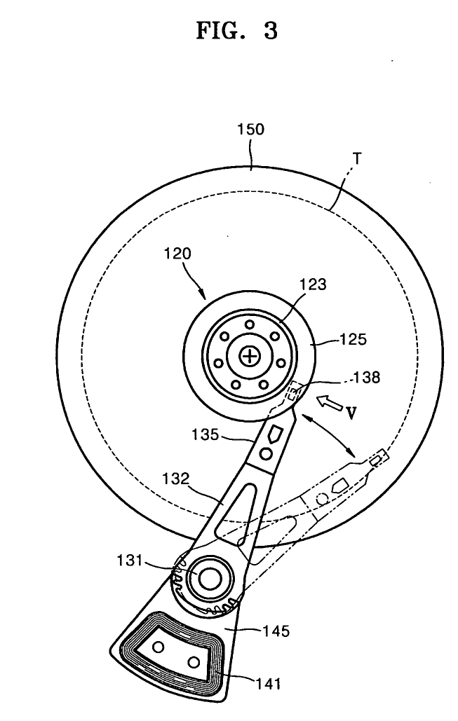

FIG. 3 is a plane view illustrating an operation of the hard disk drive of FIG. 2.

Referring to FIG. 3, when the hard disk drive is turned on and the data storage disk 150 starts rotating, the swing arm 132 is pivoted around the actuator pivot 131 in a first direction (for example, clockwise) by the voice coil motor to move the read/write head 138 from the parking region P (see FIG. 2) along the recording surface of the data storage disk 150. For example, the recording surface of the data storage disk 150 indicates a data region from which the parking region P is excluded. When the data storage disk 150 rotates, an air flow is generated around the data storage disk 150. The air flow generates a lifting force which raises the read/write head 138 above the recording surface by a predetermined height. In this state, the head 138 records data on the recording surface of the data storage disk 150 or reads the data stored in the recording surface of the data storage disk 150 while following a predetermined track T.

Additionally, when the hard disk drive is turned off and the data storage disk 150 stops rotating, the swing arm 132 pivots around the actuator pivot 131 in a second direction opposite to the first direction (for example, counterclockwise) to allow the read/write head 138 to move from the recording surface of the data storage disk 150 and sit in the parking region P formed along the circumferential inner edge of the data storage disk 150.

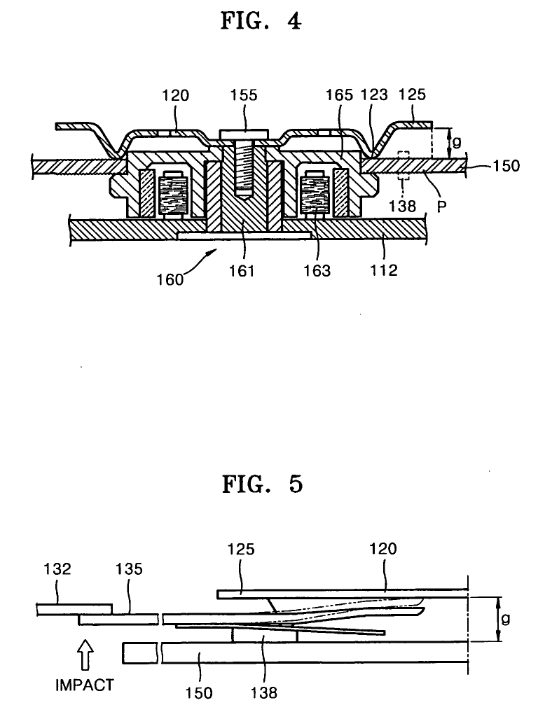

FIG. 4 is a sectional view illustrating the spindle motor assembly of the hard disk drive taken along lines IV-IV of FIG. 2. Referring to FIG. 4, the spindle motor 160 includes a shaft 161 installed on the base member 112, stators 163 fixed on an outer circumference of the shaft 161, and a rotor such as a hub 165 disposed on an outer side of the stator(s) 163. The data storage disk 150 is fitted around the hub 165. The spindle motor 160 has a top central hole to which the screw member 155 is screw-coupled. When the screw member 155 is screw-coupled to the spindle motor 160, the clamp member 120 is urged toward the data storage disk 150 by a head portion of the screw member 155. The clamp member 120 has a circumferential pressure portion 123 that is curved and protrudes toward the data storage disk 150 (i.e., downward toward the surface of the data storage disk 150). The pressure portion 123 may have a protruding part with a V-shape or a U-shape extending downward from a plane of the clamp member 120. The protruding part contacts the data storage disk 150 adjacent to where the disk 150 is fitted around the hub 165. The clamp member 120 contacts the data storage disk 150 while exerting a predetermined pressure as the circumferential pressure portion 123 is resiliently deformed. The vibration restriction portion 125 extends in a radial direction from the circumferential pressure portion 123 and vertically corresponds to the parking region P. In other words, the vibration restriction portion 125 extends in a horizontal direction, while the circumferential pressure portion 123 extends in the vertical direction. A predetermined marginal gap “g” is formed between the vibration restriction portion 125 of the clamp member 120 and the parking region P of the data storage disk 150. The marginal gap “g” prevents a front end of the suspension 135 to which the read/write head 138 is attached from interfering with the clamp member 120 when the read/write head 138 is moved into or out of the parking region P. The marginal gap “g” may be formed as small as possible within a range not to interfere with the movement of the read/write head 138 such that an effect of impact to the hard disk drive can be minimized. This will be now described in more detail.

FIG. 5 is a side view illustrating the hard disk drive of FIG. 3 as seen from a direction V, when the read/write head 138 is parked in the parking region P of the data storage disk 150 (i.e., between the parking region P of the disk 150 and the vibration restriction portion 125). When an impact is vertically applied to the hard disk drive that is not operating (i.e., the read/write head 138 is parked in the parking region P and the data storage disk 150 is not rotating), for example, when an impact is applied to the hard disk drive in a vertical upward direction, the suspension 135 having relatively low strength is biased downward and bounces back by its elastic restoring force in a vertical upward direction. At this point, the read/write head 138 rapidly rises together with the suspension 135 and collides with the vibration restriction portion 125 of the clamp member 120 to generate a repulsive collision force by which the suspension 135 moves again downward. When the marginal gap “g” is not limited within a predetermined range and the suspension 135 repeats the above described movement, the read/write head 138, being in a standing position, collides with the surface of the data storage disk 150. Thus, corners of the read/write head 138 collide repeatedly with the surface of the data storage disk 150. As described above, as the impact concentrates on the corners of the read/write head 138, the read/write head 138 may be physically damaged and dents may be formed on the surface of the data storage disk 150.

However, in the present embodiment, since the vibration restriction portion 125 extending in the radial direction is formed on the outer circumference of the clamp 120, an amount of the vertical movement of the read/write head 138 is reduced when the impact is applied. Furthermore, since the marginal gap “g” is narrowly formed (i.e., the marginal gap “g” is within a predetermined range), the read/write head 138 is forcibly maintained parallel to the surface of the data storage disk 150. Thus, an entire bottom surface instead of the corners of the read/write head 138 of the read/write head 138 collides with the surface of the data storage disk 150. That is, the collision area between the read/write head 138 and the data storage disk 150 increases. As a result, the damage of the read/write head 138 is prevented and the formation of the dents on the surface of the data storage disk 150 can be reduced or entirely avoided. The predetermined range of the marginal gap “g” may be set to be slightly larger than the read/write head 138 combined with the suspension 135.

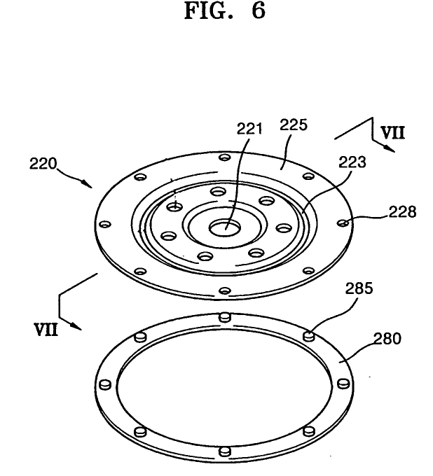

FIG. 6 is a perspective view illustrating a damping member 280 and a clamp member 220 according to another embodiment of the present general inventive concept. Referring to FIG. 6, the clamp member 220 has a central hole 221 through which the screw member 155 penetrates and a circumferential pressure portion 223 formed around the central hole 221 to extend toward the surface of the disk 150. A circumferential vibration restriction portion 225 is formed on an outer edge of the clamp member 220 and is elevated upward so that the vibration restriction portion 225 is spaced apart from the surface of the disk 150 by a predetermined height. Similar to the foregoing embodiment, the circumferential vibration restriction portion 225 restricts the vertical vibration of the read/write head 138 that is in a parking state (i.e., in the parking region P) when an impact is applied to the hard disk drive. Thus, the damage of the read/write head 138 and the disk 150 caused by the collision thereof can be prevented.

The damping member 280 is coupled to a bottom surface of the clamp member 220, which faces the surface of the disk 150. The damping member 280 has a rim-shape corresponding to a circumferential edge of the clamp member 220 and is coupled to a bottom of the circumferential edge of the clamp member 220. The damping member 280 has a plurality of coupling protrusions 285 spaced apart from each other by a predetermined distance or interval and extending toward the clamp member 220. The protrusions 285 are fitted in respective coupling holes 228 formed in the clamp member 220. The damping member 280 may be made of a different material than the clamp member 220, and may be softer or less rigid than the clamp member 220.

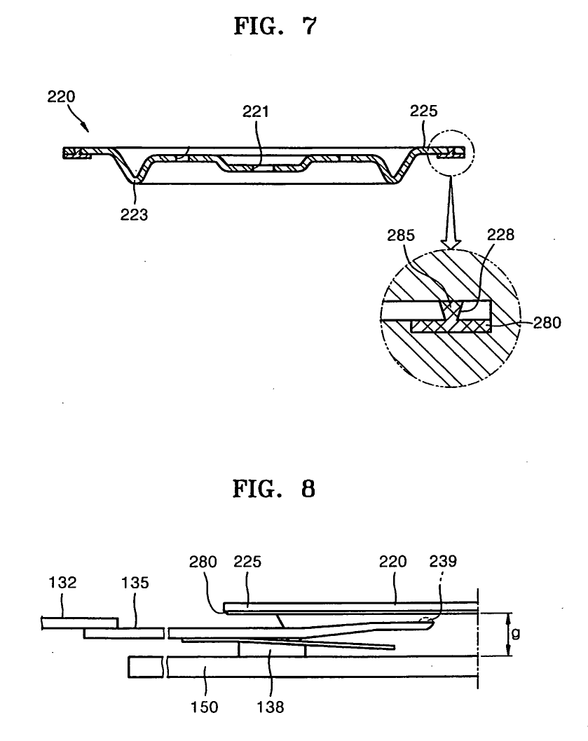

FIG. 7 is a sectional view illustrating the damping member 280 and the clamp member 220 taken along lines VII-VIl of FIG. 6. As illustrated in FIG. 7, side surfaces of each coupling projection 285 may be obliquely inclined so as not to be released from the respective corresponding coupling hole 228.

FIG. 8 is a side view illustrating a portion of a hard disk drive employing the clamp member 220 and the damping member 280 of FIG. 6. Referring to FIG. 8, the vibration restriction portion 225 is positioned along an outer edge of the clamp member 220 to face the surface of the disk 150 with the marginal gap “g? defined therebetween. The read/write head 138 is parked between the vibration restriction portion 225 and the surface of the disk 150. The damping member 280 is coupled to the bottom surface of the vibration restriction portion 225. When the read/write head 138 collides with the vibration restriction portion 225 due to an impact, the damping member 280 restricts the vibration of the suspension 135 by absorbing an energy of the impact of the read/write head 138 and by reducing a repulsive force applied from the vibration restriction portion 225 to the read/write head 138. The damping member 280 may be formed of any material having a damping capability to absorb a vibration. For example, the damping member 280 may be formed of a plastic material. Alternatively, other materials that achieve the purposes set forth herein may also be used. For example, the damping member 280 may be made of a viscoelastic material, for example, rubber.

The clamp members 220 and the damping member 280 may be prepared or manufactured as independent units from each other, and may be subsequently assembled with each other by fitting the coupling protrusions 285 of the damping member 280 into the coupling holes 228 of the clamp member 220 (see FIG. 6). Alternatively, the damping member 280 may be integrally formed on the clamp member 220 through an injection molding process. When the damping member 280 is attached to the bottom surface of the vibration restriction portion 225 of the clamp member 220, the damping member 280 absorbs vibration energy of the suspension 135 vertically vibrating between the vibration restriction portion 225 and the disk 150, thereby quickly attenuating the vibration.

Additionally, a damping protrusion 239 may be formed on a front end of the suspension 135. The damping protrusion 239 may be formed in, for example, a semi-spherical shape. When the suspension 135 vertically vibrates due to the impact, the damping protrusion 239 absorbs the energy of the impact applied to the suspension 135 when the front end of the suspension 135 collides with the vibration restriction portion 225 of the clamp member 220. As a result, the vibration of the suspension 135 is quickly attenuated to securely protect the read/write head 138 and the data storage disk 150. The damping protrusion 239 may be formed of any material having a damping capability to absorb the vibration. For example, the damping protrusion 239 may be formed of a plastic material having a flexible property. When the damping protrusion 239 is disposed on the front end of the suspension 135, the damping protrusion 239 quickly absorbs and attenuates the vibration energy of the suspension 135 vertically vibrating between the clamp member 220 and the data storage disk 150. Thus, the suspension 135 can be more effectively protected.

According to embodiments of the present general inventive concept, since a hard disk drive employs a contact start stop (CSS) type parking system, a size, a weight, and a thickness of the hard disk drive can be reduced, thereby reducing a manufacturing cost of the hard disk drive. Furthermore, since a vibration restriction portion to restrict a vibration of a suspension within a predetermined range is provided on a circumferential outer edge of a clamp member, which clamps a data storage disk to a spindle motor, a physical damage of a read/write head attached to the suspension can be prevented and an anti-impact property is improved.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A spindle motor assembly, comprising:
a data storage disk to store data and having a parking region in which to park a read/write head;
a spindle motor to drive the data storage disk, the spindle motor having a hub around which the data storage disk is fitted; and
a clamp member to fix the data storage disk on the hub, the clamp member having a vibration restriction portion formed along a circumferential outer edge thereof to face the parking region to form a marginal gap with a surface of the data storage disk.

2. The spindle motor assembly of claim 1, wherein the clamp member includes a circumferential pressure portion gently protruding toward the surface of the disk and urged to contact the surface of the disk, and the vibration restriction portion extends from the circumferential pressure portion in a radial direction.

3. The spindle motor assembly of claim 1, further comprising:
a damping member disposed on a surface of the vibration restriction portion to face the disk.

4. The spindle motor assembly of claim 3, wherein the damping member is integrally formed with the clamp member through an injection molding process.

5. The spindle motor assembly of claim 3, wherein the damping member is formed to have a rim-shape corresponding to the vibration restriction portion and a plurality of coupling protrusions spaced apart from each other by a predetermined distance.

6. The spindle motor assembly of claim 5, wherein the vibration restriction portion includes a plurality of coupling holes in which the respective protrusions of the damping member are fitted.

7. The spindle motor assembly of claim 3, wherein the damping member is formed of a flexible plastic material.

8. The spindle motor assembly of claim 1, wherein the parking region is formed on a circumferential inner edge of the disk.

9. The spindle motor assembly of claim 1, wherein the read/write head is located between the parking region of the disk and the vibration restriction portion of the clamp member when the disk stops rotating.

10. A spindle motor assembly, comprising:
a spindle motor;
a disk disposed on the spindle motor and being rotatable by the spindle motor; and
a clamp member disposed on the disk to clamp the disk to the spindle motor and having a pressure portion to contact the disk around a circular portion thereof and a vibration restriction portion extending away from the pressure portion along a surface of the disk to define a space with the surface of the disk along an outer circumference of the pressure portion.

11. The spindle motor assembly of claim 10, wherein the clamp member defines a plane that is parallel to the disk such that the pressure portion extends along a first direction perpendicular to the defined plane and the vibration restriction portion extends along a second direction parallel to the defined plane.

12. The spindle motor assembly of claim 10, wherein the clamp member has a damping member coupled to the vibration restriction portion in the defined space, and the damping member is a different material from the clamp member.

13. The spindle motor assembly of claim 10, wherein the disk includes a parking region in which a magnetic head is parkable, and the vibration restriction portion is disposed adjacent to the parking region of the disk.

14. A hard disk drive, comprising:
an actuator to move a read/write head attached to a front end thereof to a selected location;
a data storage disk to store data and having a parking region in which to park the read/write head;
a spindle motor to drive the data storage disk and having a hub around which the data storage disk is fitted; and
a clamp member to fix the data storage disk on the hub and having a vibration restriction portion formed on a circumferential outer edge thereof, the vibration restriction portion facing the parking region and forming a marginal gap with the disk.

15. The hard disk drive of claim 14, wherein the actuator comprises:
a suspension to which the read/write head is attached and having a damping protrusion formed at a front end thereof;
a swing arm to support the suspension and to pivot about a pivot axis; and
a voice coil motor to drive the swing arm.

16. The hard disk drive of claim 15, wherein the damping protrusion is semi-spherical.

17. The hard disk drive of claim 15, wherein the damping protrusion is formed of a flexible plastic material.

18. A hard disk drive, comprising:
a spindle motor;
a disk disposed on the spindle motor;
a clamp member disposed on the disk and the spindle motor to clamp the disk to the spindle motor and having a restriction portion extending parallel to the disk around an outer circumference of the clamp member; and
a magnetic head assembly having a suspension with a magnetic head disposed thereon that is movable between the restriction portion and the disk.

19. The hard disk drive of claim 18, wherein movement of the magnetic head between the restriction portion of the clamp member and the disk is limited to movement in a direction that is parallel to the disk.

20. The hard disk drive of claim 18, further comprising:
a housing to house the spindle motor, the disk, the clamp member, and the magnetic head assembly such that when the housing receives an external impact in a predetermined direction that is perpendicular to the disk, the restriction portion attenuates movement of the suspension in the predetermined direction that results from the external impact.
